(19) United States
(12) Patent Application Publication
(10) Pub. No.: US 2010/0124696 A1
(43) Pub. Date: May 20, 2010

(54) BATTERY COVER MECHANISM

(75) Inventors: RUI-HAO CHEN, Shenzhen City (CN); ZHUO CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/557,698

(22) Filed: Sep. 11, 2009

(30) Foreign Application Priority Data
Nov. 17, 2008 (CN) 200810305595.6

(51) Int. Cl. H01M 2/10

(52) U.S. Cl. 429/96

(57) ABSTRACT

A battery cover mechanism for a portable electronic device, includes a housing having sliding grooves defined at each side thereof, a cover forming rail sections at the to sides thereof to correspondingly engage with the sliding grooves, and an elastic module. The elastic module connects to the housing and the cover respectively, after the cover slides a predetermined distance relative to the housing, the elastic module provides elastic force to slide the cover further.

### BACKGROUND

1. Field of the Invention

The present invention relates to battery cover mechanisms, particularly to a battery cover mechanism used in portable electronic devices.

2. Description of Related Art

Portable electronic devices such as mobile phones and personal digital assistants (PDAs) are widely used. When a battery is installed in the portable electronic device, the battery is generally shielded and fixed in place by a battery cover mechanism.

A typical battery cover mechanism includes a cover and a housing. The cover includes a pin at on one end and a protrusion at an opposite end. The housing defines a receiving hole and a holding aperture. The protrusion can be received into the holding aperture, and the cover can be impelled towards the housing until the pin is received into the receiving hole. As such, the cover securely engages with the housing. However, the cover is opened/shut manually in all process, this is not always convenient.

Therefore, there is room for improvement within the art.

### BRIEF DESCRIPTION OF THE DRAWINGS

Many aspects of the present battery cover mechanism can be better understood with reference to the following drawings. The components in the various drawings are not necessarily drawn to scale, the emphasis instead being placed upon clearly illustrating the principles of the present battery cover mechanism. Moreover, in the drawings, like reference numerals designate corresponding parts throughout the diagrams.

FIG. 1 is a disassembled view of the battery cover mechanism, according to an exemplary embodiment.

FIG. 2 is a schematic view of the battery cover of the battery cover mechanism shown in FIG. 1.

FIG. 3 is an opened schematic view of the battery cover relative to the housing shown in FIG. 1.

FIG. 4 is a schematic view of the battery cover sliding at the critical position of the housing shown in FIG. 1.

FIG. 5 is a closed schematic view of the battery cover relative to the housing shown in FIG. 1.

### DETAILED DESCRIPTION OF THE EMBODIMENT

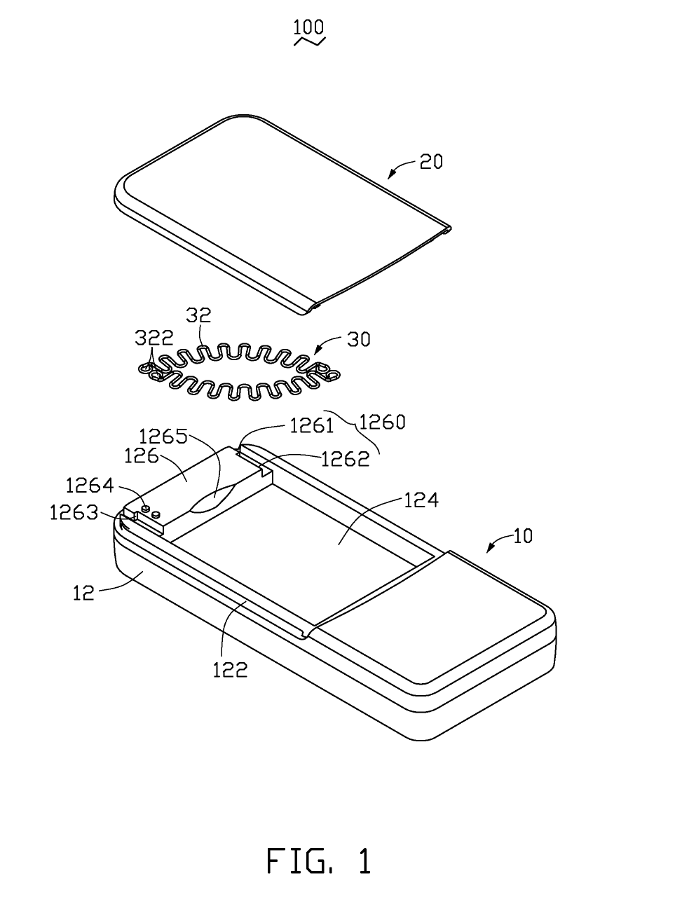

Referring to FIG. 1, the battery cover mechanism 100 can be used in mobile phones, and can also used in other portable electronic devices, such as personal digital assistants (PDAs), digital cameras, etc. The battery cover mechanism 100 includes a housing 10, a cover 20, and an elastic module 30. The elastic module 30 connects the housing 10 and the cover 20, and the cover 20 slidably engages the housing 10.

The housing 10 includes an engaging end portion 12 engagable with the cover 20. The engaging end portion 12 defines sliding grooves 122 in opposite sides of the housing 10, and an exposed battery receiving cavity 124 in the middle of the housing 10. The engaging end portion 12 forms an assembly seat 126 near the receiving cavity 124, at an end of the housing 10. The assembly seat 126 defines assembly grooves 1260 at opposite sides of the assembly seat 126. The assembly groove 1260 extends parallel to the sliding grooves 122 and to the outside of the device. Each assembly groove 1260 includes a narrow first groove passage 1261, and a wide second groove passage 1262 communicating with the receiving cavity 124. Two stepped limiting portions 1263 are formed separating the first groove passage 1261 and the second groove passage 1262. The assembly seat 126 has two first connecting poles 1264 protruding from the top surface adjacent to a side of the assembly seat 126 for fixing the elastic module 30. The assembly seat 126 defines a cutout 1265 adjacent the receiving cavity 124 to facilitate removing the battery out from the receiving cavity 124.

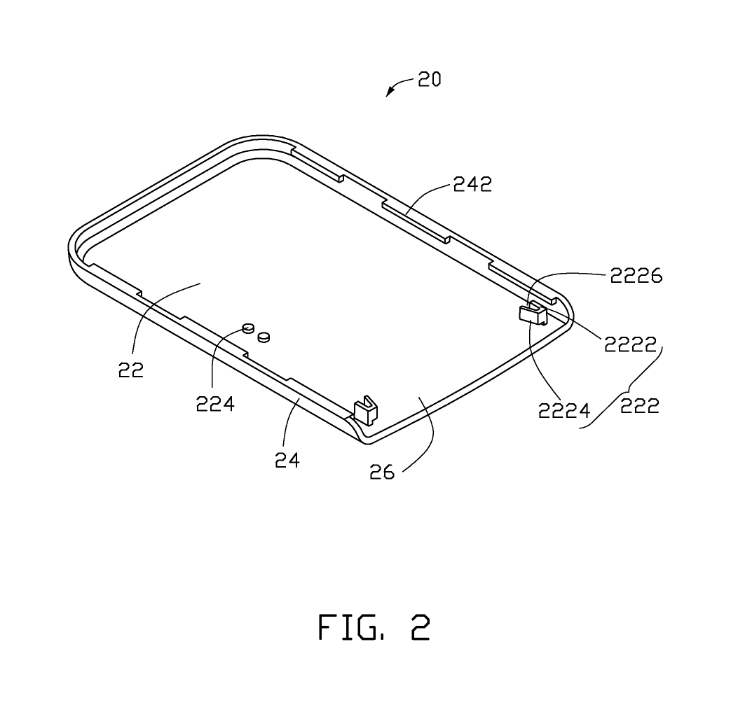

Referring to FIG. 2, the cover 20 includes a sheet portion 22 and flanges 24 at opposite sides of the sheet portion 22. The flanges 24 and the sheet portion 22 cooperatively enclose an opening 26. The sheet portion 22 has two stop portions 222 and two second connecting poles 224 formed on the inner surface. The two stop portions 222 are located adjacent the opening 26 and the two flanges 24. The stop portions 222 are generally wedge-shaped and correspondingly engageable with/in the assembly grooves 1260. Each stop portion 222 includes a guiding wall 2222 and an elastic wall 2224. The guiding wall 2222 is arranged parallel with the flange 24. The elastic wall 2224 extends and inclines from an end of the guiding wall 2222 to form V-shaped portion 2226 inside the opening 26. The width of V-shaped portion 2226 is substantially the same as the second groove passage 1262. The elastic wall 2224 can be pressed towards the guiding wall 222 to deform the V-shaped portion 2226. The two second connecting poles 224 are positioned at the middle of the sheet portion 22 approximate to the flange 24. The second connecting poles 224 connect the elastic module 30. Each of flanges 24 includes a plurality of rail sections 242 extending laterally to engage the sliding groove 122.

The elastic module 30 is a closed loop including two connected elastic bars 32. Each elastic bar 32 is a bending, curved bar-shaped spring, and has two connecting ends 322 for fixing the connecting poles 1264, 224.

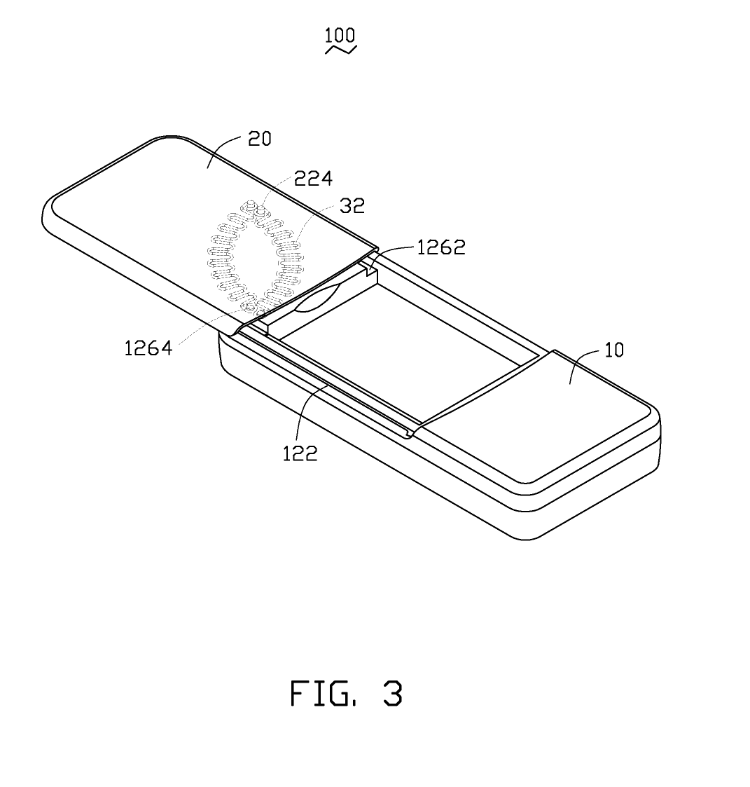

Referring to FIG. 3, during assembly, the elastic module 30 connects the housing 10 and the cover 20. The connecting ends 322 of each elastic bar 32 are secured to the first connecting pole 1264 and the second connecting pole 224 respectively. The elastic bars 32 are compressed towards each other between the connecting poles 1264, 224. The opening 26 is oriented towards the assembly seat 126. The rail sections 242 are aligned above the two sliding grooves 122 and the stop portions 222 are align with the first groove passages 1261 corresponding. The cover 20 is pushed towards the receiving cavity 124 with the elastic wall 2224 folded relative to the guiding wall 2222. The stop portions 222 are slidable in the second groove passage 1262. The elastic wall 2224 is released and the stop portion 222 is received in the second groove passage 1262. Accordingly, the stop portion 222 resists the limiting portions 1263 and prevents the stop portion 222 from separating from the first groove passage 1261 when sliding the cover 20. Thus, the cover 20 is assembled in the housing 10.

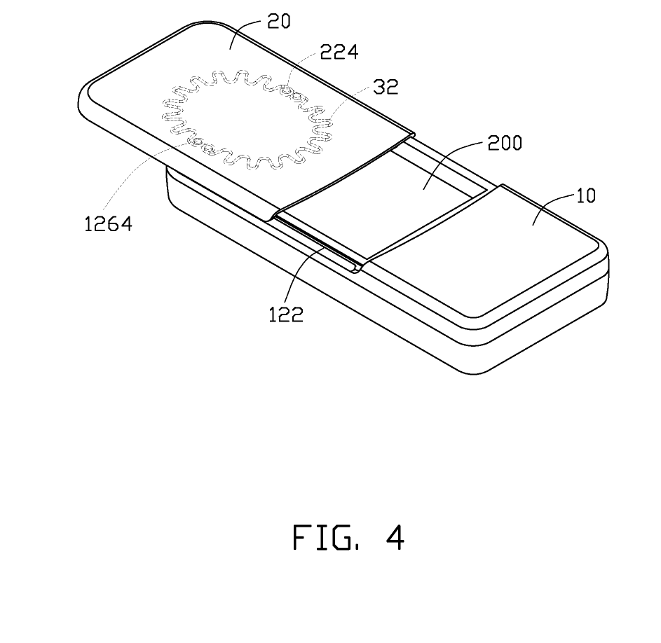

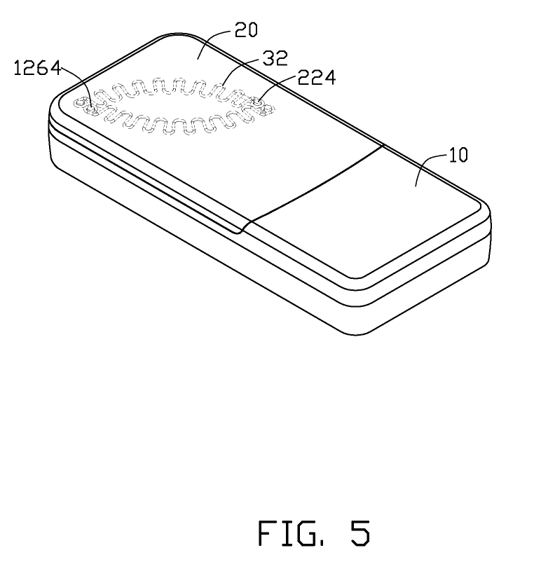

Referring further to FIGS. 4 and 5, after assembling the battery 200 into the receiving cavity 124, the cover 20 is slid to close the receiving cavity 124. Due to the deformation of the elastic bars 32, the two ends 322 approach each other and the elastic bar 32 accumulates potential elastic energy. When the cover 20 reaches the middle of the engaging end portion 12, the distance between the two ends 322 is minimized and accordingly the elastic bars 32 accumulates a maximum potential elastic energy. After the cover 20 slides beyond the middle position, the potential elastic energy of the elastic bars 32 can be momentarily released to automatically slide the cover 20. The cover 20 can slide along the sliding grooves 122 until the cover 20 fully covers the receiving cavity 124. Opening the cover 20 is opposite to closing the cover 20. The stop portion 222 cannot slide out of the assembly grooves 1260 because the elastic walls 2224 resists against the limiting portion 1263.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A battery cover mechanism for a portable electronic device, comprising:
a housing having sliding grooves defined at each side thereof,
a cover forming rail sections at the sides thereof to correspondingly engage with the sliding grooves;
wherein the battery cover mechanism includes an elastic module, the elastic module connects to the housing and the cover respectively, after the cover slides a predetermined distance relative to the housing, the elastic module provides elastic force to slide the cover further.

2. The battery cover mechanism as claimed in claim 1, wherein the housing defines a receiving cavity and forms an assembly seat, the assembly seat defines two assembly grooves extending parallel to the sliding groove and communicating with the receiving cavity to the outside, the cover forms two stop portions, the stop portions respectively engage the two assembly grooves.

3. The battery cover mechanism as claimed in claim 2, wherein the assembly groove includes a first groove passage and a second groove passage wider than the first groove passage, the first groove passage extends to the outside of the battery cover mechanism, the second groove passage extends to the receiving cavity, a stepped limiting portion separates the first groove passage and the second groove passage.

4. The battery cover mechanism as claimed in claim 3, wherein the stop portion includes a guiding wall and an elastic wall extending from an end of the guiding wall to form a V-shaped portion with the guiding wall, the width of the V-shaped portion is same as the width of the second groove passage, the elastic wall can be pressed towards the guiding wall to deform the V-shaped portion.

5. The battery cover mechanism as claimed in claim 4, wherein the cover includes a sheet portion and flanges at opposite sides of the sheet portion, the stop portions are formed at the inner surface of the sheet portion and adjacent to the two flanges, the guiding wall is parallel with the flange.

6. The battery cover mechanism as claimed in claim 5, wherein the rail sections are formed on the flange and extend laterally on the flange.

7. The battery cover mechanism as claimed in claim 5, wherein the assembly seat forms two first connecting poles, and the sheet portion forms two second connecting poles, the elastic module is fixed to the first connecting poles and the second connecting poles.

8. The battery cover mechanism as claimed in claim 7, wherein the elastic module includes two elastic bars, each elastic bar connects with the first connecting pole and the second connecting pole.

9. The battery cover mechanism as claimed in claim 8, wherein the elastic bar is a bendable curved bar-shaped spring.

10. A battery cover mechanism for a portable electronic device, comprising:
a housing having sliding grooves defined at each side thereof,
a cover forming rail sections at the sides thereof to correspondingly engage with the sliding grooves;
wherein the battery cover mechanism includes an elastic module connected to the housing and the cover respectively, the housing has assembly grooves formed therein, the cover forms stop portions, the cover slidably engages with the housing by elastic force of the elastic module, the assembly grooves engages the stop portion and prevent the cover departing from the housing.

11. The battery cover mechanism as claimed in claim 10, wherein the housing defines a receiving cavity and forms an assembly seat, the assembly seat defines the two assembly grooves extending parallel to the sliding groove and communicating with the receiving cavity to the outside, the cover forms the two stop portions respectively engage with the two assembly grooves.

12. The battery cover mechanism as claimed in claim 11, wherein the assembly groove includes a first groove passage and a second groove passage wider than the first groove passage, the first groove passage extends to the outside of the battery cover mechanism, the second groove passage extends to receiving cavity, a stepped limiting portion separates the first groove passage and the second groove passage.

13. The battery cover mechanism as claimed in claim 12, wherein the stop portion includes a guiding wall and an elastic wall extending from an end of the guiding wall to form a V-shaped portion with the guiding wall, the width of the V-shaped portion is same as the width of the second groove passage, the elastic wall can be pressed towards the guiding wall to deform the V-shaped portion.
